(19) United States
(12) Patent Application Publication
(10) Pub. No.: US 2025/0312648 A1
(43) Pub. Date: Oct. 9, 2025

(54) PERSONALIZING PREDICTION OF PERFORMANCE USING DATA AND BODY-POSE FOR ANALYSIS OF SPORTING PERFORMANCE

(71) Applicant: STATS LLC, Chicago, IL (US)

(72) Inventors: Paul David Power, Leeds (GB); Aditya Cherukumudi, London (GB); Sujoy Ganguly, Chicago, IL (US); Xinyu Wei, Melbourne (AU); Long Sha, Brisbane (AU); Jennifer HOBBS, Chicago, IL (US); Hector Ruiz, Barcelona (ES); Patrick Joseph LUCEY, Chicago, IL (US)

(73) Assignee: STATS LLC, Chicago, IL (US)

(21) Appl. No.: 19/241,003

(22) Filed: Jun. 17, 2025

Related U.S. Application Data
(63) Continuation of application No. 18/336,474, filed on Jun. 16, 2023, now Pat. No. 12,364,903.
Application No. 18/336,474 is a continuation of application No. 16/804,964, filed on Feb. 28, 2020, now Pat. No. 11,679,299.
(60) Provisional application No. 62/812,387, filed on Mar. 1, 2019.

(51) Int. Cl. A63B 24/00; G06N 3/08; G06N 20/00

(52) U.S. Cl. CPC A63B 24/0006; A63B 24/0021; A63B 24/0062; A63B 24/0087; G06N 3/08; G06N 20/00

(57) ABSTRACT

A method of generating a player prediction is disclosed herein. A computing system retrieves data from a data store. The computing system generates a predictive model using an artificial neural network. The artificial neural network generates one or more personalized embeddings that include player-specific information based on historical performance. The computing system selects, from the data, one or more features related to each shot attempt captured in the data. The artificial neural network learns an outcome of each shot attempt based at least on the one or more personalized embeddings and the one or more features related to each shot attempt.

### CROSS-REFERENCE TO RELATED APPLICATIONS

This application is a continuation of, and claims the benefit of priority to U.S. application Ser. No. 18/336,474, filed Jun. 16, 2023, which is a continuation of, and claims the benefit of priority to U.S. application Ser. No. 16/804,964, filed Feb. 28, 2020, now U.S. Pat. No. 11,679,299, issued Jun. 20, 2023, which claims the benefit of priority to U.S. Provisional Application No. 62/812,387, filed Mar. 1, 2019, each of which is incorporated herein by reference in its entirety.

### FIELD OF THE DISCLOSURE

The present disclosure generally relates to system and method for generating personalized prediction of sporting performance based on, for example, data.

### BACKGROUND

Increasingly, sports fans and data analysts have become entrenched in sports analytics, particularly in trying to determine whether the outcome of a match or game instance would change based on a change to the players in the match. For example, typical “Monday Morning Quarterback” sportscasters argue over how the outcome of a match could have changed if, for example, the coach made one or more roster adjustments. Accordingly, there is a continual competition for developing a system that can more accurately predict an outcome a game instance.

### SUMMARY

Embodiments disclosed herein generally relate to a system and method for generating shot predictions. In another embodiment, a method of generating a player prediction is disclosed herein. A computing system retrieves data from a data store. The data includes information for a plurality of events across a plurality of seasons. The computing system generates a predictive model using an artificial neural network. The artificial neural network generates one or more personalized embeddings that include player-specific information based on historical performance. The computing system selects, from the data, one or more features related to each shot attempt captured in the data. The artificial neural network learns an outcome of each shot attempt based at least on the one or more personalized embeddings and the one or more features related to each shot attempt. The computing system receives a set of data directed to a target shot attempt. The set of data includes at least the player involved in the target shot attempt and one or more features related to the target shot attempt. The computing system generates, via the predictive model, a likely outcome of the shot attempt based on personalized embeddings of the player involved in the target shot attempt and the one or more features related to the target shot attempt.

In some embodiments, a system for generating a player prediction is disclosed herein. The system includes a processor and a memory. The memory has programming instructions stored thereon, which, when executed by the processor, performs one or more operations. The one or more operations include retrieving data from a data store. The data includes information for a plurality of events across a plurality of seasons. The one or more operations further include generating a predictive model using an artificial neural network by generating, by the artificial neural network, selecting, from the data, one or more features related to each shot attempt captured in the data, and learning, by the artificial neural network, an outcome of each shot attempt based at least on the one or more personalized embeddings and the one or more features related to each shot attempt. The one or more personalized embeddings include player-specific information based on historical performance. The one or more operations further include receiving a set of data directed to a target shot attempt. The set of data includes at least the player involved in the target shot attempt and one or more features related to the target shot attempt. The one or more operations further include generating, via the predictive model, a likely outcome of the shot attempt based on personalized embeddings of the player involved in the target shot attempt and the one or more features related to the target shot attempt.

In another embodiment, a non-transitory computer readable medium is disclosed herein. The non-transitory computer readable medium includes one or more sequences of instructions that, when executed by the one or more processors cause a computing system to perform one or more operations. The computing system retrieves data from a data store. The data includes information for a plurality of events across a plurality of seasons. The computing system generates a predictive model using an artificial neural network. The artificial neural network generates one or more personalized embeddings that include player-specific information based on historical performance. The computing system selects, from the data, one or more features related to each shot attempt captured in the data. The artificial neural network learns an outcome of each shot attempt based at least on the one or more personalized embeddings and the one or more features related to each shot attempt. The computing system receives a set of data directed to a target shot attempt. The set of data includes at least the player involved in the target shot attempt and one or more features related to the target shot attempt. The computing system generates, via the predictive model, a likely outcome of the shot attempt based on personalized embeddings of the player involved in the target shot attempt and the one or more features related to the target shot attempt.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating a structure of an artificial neural network, according to example embodiments.

FIG. 3 is a flow diagram illustrating a method of generating a fully trained prediction model, according to example embodiments.

FIG. 4 is a flow diagram illustrating a method of generating a shot prediction using the fully trained prediction model, according to example embodiments.

FIG. 5A is a flow diagram illustrating a method of generating player rankings based on a number of simulated goals conceded, according to example embodiments.

FIG. 5B is a block diagram of a graphical user interface illustrating player rankings, according to example embodiments.

FIG. 6A is a flow diagram illustrating a method of comparing players using a simulation process, according to example embodiments.

FIG. 6B is a block diagram of a graphical user interface illustrating a simulated shot map, according to example embodiments.

FIG. 7A is a flow diagram illustrating a method of comparing player seasons using a simulation process, according to example embodiments.

FIG. 7B is a block diagram of a graphical user interface illustrating a simulated shot map, according to example embodiments.

FIG. 8A is a block diagram illustrating a computing device, according to example embodiments.

FIG. 8B is a block diagram illustrating a computing device, according to example embodiments.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

One or more techniques disclosed herein generally relate to a system and a method for generating a goalkeeper prediction. In other words, one or more techniques disclosed herein relate to a system and method for predicting the likelihood a goalkeeper would concede or block a shot attempt based on, for example, one or more shot parameters and personalized information about the goalkeeper.

Late in the 2018 Champions League Final between Real Madrid and Liverpool, with the score 2-1 in favor of Real Madrid, Real Madrid's player, Gareth Bale, took aim at Liverpool goalkeeper Loris Karius from 35 yards away with a powerful, yet straight, shot. The ball ended up sailing through Karius' hands, effectively giving Real Madrid their third straight title. The reaction to the loss was immediate by Liverpool, with the club breaking the world record for a goalkeeper by purchasing Brazilian Alisson for 67 million from AS Roma.

While this transfer triggered a flurry of other high-priced goalkeeper transfers between the top European leagues, putting the cost of goalkeepers at an all-time high, it begs the questions: 1) how can one compare the performance of different goalkeepers across teams and leagues?; and 2) how can one approximate whether or not a goalkeeper will be a success on a specific team?

Conventional approaches assess goalkeepers using coarse metrics, such as “clean-sheets,” “total goals conceded,” or “shots saved to goals conceded” ratio. More recently, conventional systems implement “expected metrics,” such as expected saves (xS) to compare goalkeeper performance to league average. Problems arise with these methods, however, because goalkeepers may have different types of saves to make depending on the style of the team and the opponents they face.

Instead of using metrics, which may not capture all the different situations and contexts, the one or more techniques disclosed herein go beyond metrics, by simulating each goalkeeper for every shot, and comparing who would concede the most goals. For example, the one or more techniques disclosed herein may provide an answer to the question: If Alisson played for Liverpool last year, how many goals would he have saved/conceded based on the shots that Liverpool faced during the season?

Even though the concept may seem simple on its face, the process of accurately simulating the swapping of different goalkeepers for specific situations is challenging due to several factors, such as, but not limited to:

The lack of specific examples for each goalkeeper: such task would be easier if the goalkeeper faced, for example, one million shots per season. However, given that each goalkeeper, on average, faces two to five shots on target per game (around 70-150 shots on target per season for a 38 game season), a goal keeper may only face a couple of shots per location/context, or may not at all be based on whom they play for. For example, a goalkeeper who plays for a team that generally sits back deeply defensively may not face many counter-attacking shots, or another goalkeeper who plays on a team who is very strong on set-pieces, may not actually face many shots from set-pieces.

The changing form of a goalkeeper: due to injury, fatigue, age, confidence, improvements in skill, coaching, etc., a goalkeeper's form may change across the course of a season and/or career. Such change may result in previous examples of goalkeeper saves being no longer relevant (i.e., examples may not be predictive of current or future performance).

The data is not granular enough: the observation for each shot may only be restricted to x, y position of the host location, the x, y goalkeeper location at the time of the strike, the x, y final ball position (with the associated player identities). To more accurately predict the likelihood of a goalkeepers saving a shot, body pose position (i.e., whether they crouched, stood up straight/unbalanced, arms wide, striker body pose, etc.), may be useful for such analysis.

To address such challenges, the one or more techniques described herein utilize a personalized prediction approach using dynamic spatial features within a deep learning framework. In particular, the technique described herein may employ a feed forward neural network with a combination of fixed (e.g., shot and goalkeeper locations) and dynamically updated (e.g., player form, time in game, scoreline, etc.) embeddings and features to predict the chance of a shot being saved (e.g., expected saves), where a shot will be placed, and critically allow the interface between goalkeepers to compare performance in the same situations.

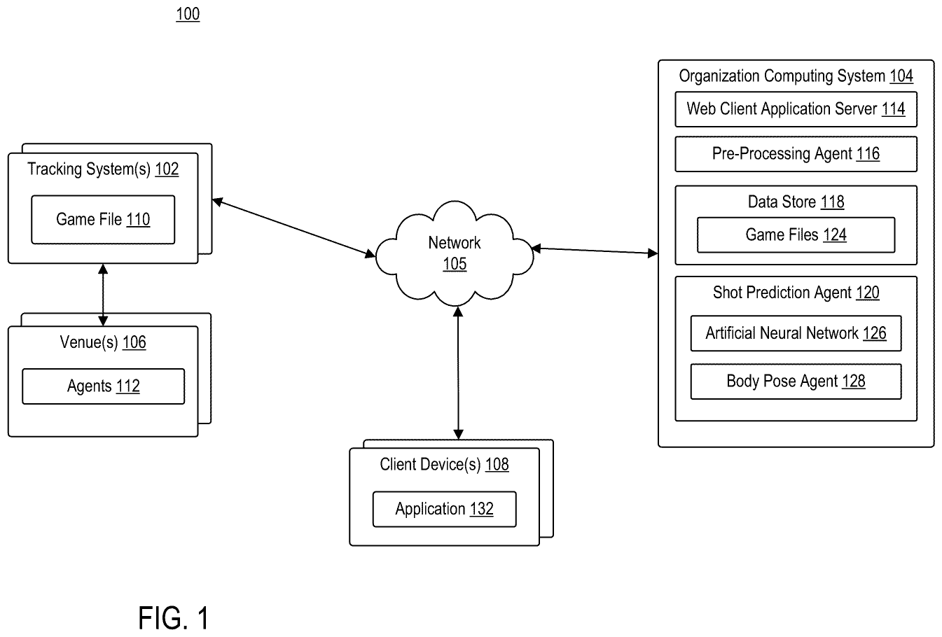

FIG. 1 is a block diagram illustrating a computing environment 100, according to example embodiments. Computing environment 100 may include tracking system 102, organization computing system 104, and one or more client devices 108 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data or information. For example, network 105 may be the Internet, a private data network, virtual private network using a public network and/or other suitable connection(s) that enables components in computing environment 100 to send and receive information between the components of environment 100.

Tracking system 102 may be positioned in a venue 106. For example, venue 106 may be configured to host a sporting event that includes one or more agents 112. Tracking system 102 may be configured to record the motions of all agents (i.e., players) on the playing surface, as well as one or more other objects of relevance (e.g., ball, referees, etc.). In some embodiments, tracking system 102 may be an optically-based system using, for example, a plurality of fixed cameras. For example, a system of six stationary, calibrated cameras, which project the three-dimensional locations of players and the ball onto a two-dimensional overhead view of the court may be used. In some embodiments, tracking system 102 may be a radio-based system using, for example, radio frequency identification (RFID) tags worn by players or embedded in objects to be tracked. Generally, tracking system 102 may be configured to sample and record, at a high frame rate (e.g., 25 Hz). Tracking system 102 may be configured to store at least player identity and positional information (e.g., (x, y) position) for all agents and objects on the playing surface for each frame in a game file 110.

Game file 110 may be augmented with other event information corresponding to event data, such as, but not limited to, game event information (pass, made shot, turnover, etc.) and context information (current score, time remaining, etc.).

Tracking system 102 may be configured to communicate with organization computing system 104 via network 105. Organization computing system 104 may be configured to manage and analyze the data captured by tracking system 102. Organization computing system 104 may include at least a web client application server 114, a pre-processing engine 116, a data store 118, and scoring prediction agent 120. Each of pre-processing engine 116 and shot prediction engine 120 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of the instructions.

Data store 118 may be configured to store one or more game files 124. Each game file 124 may include spatial event data and non-spatial event data. For example, spatial event data may correspond to raw data captured from a particular game or event by tracking system 102. Non-spatial event data may correspond to one or more variables describing the events occurring in a particular match without associated spatial information. For example, non-spatial event data may include each shot attempt in a particular match. In some embodiments, non-spatial event data may be derived from spatial event data. For example, pre-processing engine 116 may be configured to parse the spatial event data to derive shot attempt information. In some embodiments, non-spatial event data may be derived independently from spatial event data. For example, an administrator or entity associated with organization computing system may analyze each match to generate such non-spatial event data. As such, for purposes of this application, event data may correspond to spatial event data and non-spatial event data.

In some embodiments, each game file 124 may further include the current score at each time, t, during the match, the venue at which the match is played, the roster of each team, the minutes played by each team, and the stats associated with each team and each player.

Pre-processing agent 116 may be configured to process data retrieved from data store 118. For example, pre-processing agent 116 may be configured to generate one or more sets of information that may be used to train one or more neural networks associated with scoring prediction agent 120. Pre-processing agent 116 may scan each of the one or more game files stored in data store 118 to identify one or more statistics corresponding to each specified data set, and generate each data set accordingly. For example, pre-processing agent 116 may scan each of the one or more game files in data store 118 to identify one or more shots attempted in each game, and identify one or more coordinates associated therewith (e.g., shot start coordinates, end location coordinates, goalkeepers start position coordinates, etc.).

Scoring prediction agent 120 may be configured to generate “personalized predictions” for the outcome of a particular scoring event. In some embodiments, a sporting event may be defined as a scoring attempt during the course of a sporting event. Exemplary scoring events may include, but are not limited to, basketball shot attempt, free-throw attempt, touchdown pass attempt, touchdown rush attempt, field-goal attempt, hockey shot attempt, hockey penalty shot attempt, baseball at-bat, soccer shot attempt, soccer penalty kick attempt, golf putt attempt, golf swing attempt, and the like. Although the below discussion focuses on a particular example related to soccer, those skilled in the art may readily understand that such operations may be extended to one or more scoring events in any type of sporting event. In some embodiments, scoring prediction agent 120 may be configured to generate a predicted outcome of a shot based on at least one or more of shot start position (x, y), shot end location (x, y, z), goalkeeper start position (x, y), time in game, half, score, venue, player identities (e.g., goalkeeper identities), one or more handcrafted geometric features, and body pose information. Accordingly, scoring prediction agent 120 may generate the predicted outcome of a shot based on one or more fixed variables and one or more dynamically updated embeddings and features to predict the chance of a shot being saved, where a shot may be placed, and the like. In some embodiments, scoring prediction agent 120 may be configured to critically allow for the interchange of goalkeepers to compare performance, if given the same situation (i.e., same shot attempt). Still further, in some embodiments, scoring prediction agent 120 may be configured to allow for the analysis of a given goalkeeper across the goalkeeper's career.

Scoring prediction agent 120 may include artificial neural network 126 and body pose agent 128. Artificial neural network 126 may be configured to predict whether a given shot will be successfully defended (i.e., no goal) or unsuccessfully defended (i.e., goal) which agents are in an event (e.g., on the court) at a given time. For example, neural network module 220 may be configured to learn how to predict an outcome of a given shot based on, for example, one or more of shot start position (x, y), shot end location (x, y, z), goalkeeper start position (x, y), time in game, half, score, venue, player identities (e.g., goalkeeper identities), one or more handcrafted geometric features, and body pose information.

Body pose agent 128 may be configured to generate one or more metrics related to the body pose of at least one or more of a goalkeeper and a shooter for a given shot. In some embodiments, body pose agent 128 may generate body pose information based on event data captured by tracking system 102. In some embodiments, body-post agent 128 may generate body pose information from a broadcast stream provided by a broadcast provider. Body-post agent 128 may be able to identify, for example, shooter start position and angle, run type (e.g., stutter and speed), shot initiation (e.g., body lean angle, upper body angle, hip orientation, kicking arm position, shoulder alignment, etc.), and the like. Additionally, the raw positions of the body-positions in 2D or 3D which appear as a skeleton can be used to detect and correlate specific key actions in sports.

Client device 108 may be in communication with organization computing system 104 via network 105. Client device 108 may be operated by a user. For example, client device 108 may be a mobile device, a tablet, a desktop computer, or any computing system having the capabilities described herein. Users may include, but are not limited to, individuals such as, for example, subscribers, clients, prospective clients, or customers of an entity associated with organization computing system 104, such as individuals who have obtained, will obtain, or may obtain a product, service, or consultation from an entity associated with organization computing system 104.

Client device 108 may include at least application 126. Application 126 may be representative of a web browser that allows access to a website or a stand-alone application. Client device 108 may access application 126 to access one or more functionalities of organization computing system 104. Client device 108 may communicate over network 105 to request a webpage, for example, from web client application server 114 of organization computing system 104. For example, client device 108 may be configured to execute application 126 to access content managed by web client application server 114. The content that is displayed to client device 108 may be transmitted from web client application server 114 to client device 108, and subsequently processed by application 126 for display through a graphical user interface (GUI) of client device 108.

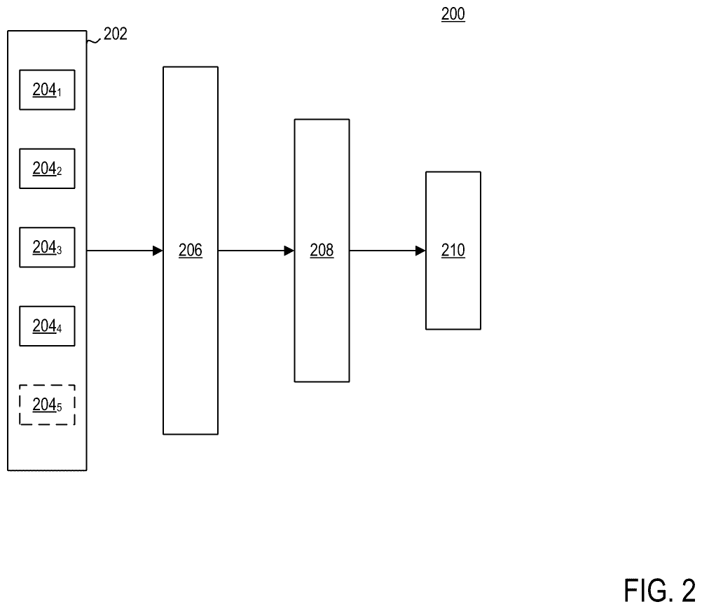

FIG. 2 is a block diagram illustrating artificial neural network (ANN) structure 200, according to example embodiments. ANN structure 200 may represent artificial neural network 126.

ANN structure 200 may represent a four-layer feed forward neural network. As illustrated, ANN structure 200 may include input layer 202, first hidden layer 206, second hidden layer 208, and an output layer 210.

Input layer 202 may be representative of one or more inputs 204₁-204₅ (generally, “inputs 204”) provided to artificial neural network 126. For example, input 204₁ may be directed to shot start locations, input 204₂ may correspond to goalkeeper locations, input 204₃ may correspond to scores, times, and shot end locations, input 2044 may correspond to dynamic goalkeeper embeddings, and input 2045 may correspond to body pose information.

In some embodiments, to train and test artificial network 126, the one or more inputs 204 in input layer 202 may be selected from three seasons worth of data (e.g., 2016-2018) from 54 different leagues/competitions across the world with a sample of about 150,000 (e.g., 45,000 goals, 105,000 saves) shots on target faced by over 2000 goalkeepers. The information may be split into training sets and test sets (e.g., 80%/20%, respectively).

First hidden layer 206 may be of size 12. For example, first hidden layer 206∈ [symbol] ¹². First hidden layer 206 may use rectified linear unit (ReLu) activation function. Second hidden layer 208 may be of size 8. For example, second hidden layer 208∈ [symbol] ⁸. Second hidden layer 208 may be implemented with ReLu activation function.

Output layer 208 may be configured to generate an output prediction. For example, output layer 208 may be configured to output “goal” or “save” as possible options for each respective shot. Output layer 208 may be implemented with sigmoid activation function.

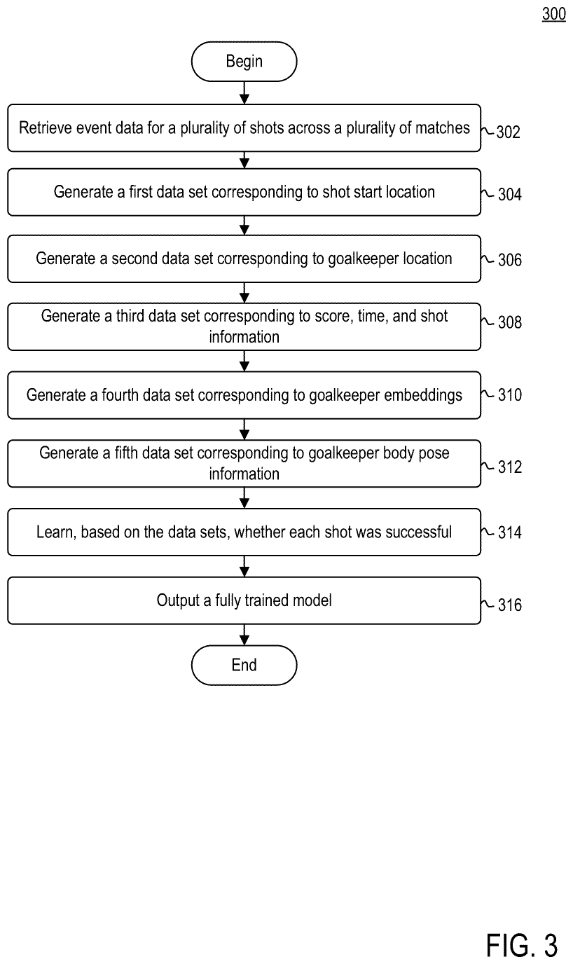

FIG. 3 is a flow diagram illustrating a method 300 of generating a fully trained prediction model, according to example embodiments. Method 300 may begin at step 302.

At step 302, scoring prediction agent 120 may retrieve event data for a plurality of scoring attempts (e.g., shot attempts in soccer) across a plurality of matches. For example, scoring prediction agent 120 may retrieve spatial event data from data store 118. Spatial event data may capture every touch of the ball, with x, y coordinates and time stamps, as well as non-spatial event data, i.e., one or more variables describing one or more events without associated spatial information. In some embodiments, pre-processing agent 112 may be configured to parse through the retrieved event data to identify one or more portions of event data that include shot attempts. For example, pre-processing agent 112 may extract one or more portions from the event data, such that only event data corresponding to shot attempts are included therein.

At step 304, scoring prediction agent 120 may generate a first data set corresponding to a scoring attempt start location. For example, scoring prediction agent 120 may parse through the one or more sets of event data retrieved from data store 118 to identify shot start location for each shot identified therein. In some embodiments, shot start location information may include x, y data coordinates. In some embodiments, shot start location information may include x, y, z data coordinates. For example, additional contextual features such as, but not limited to, a headed shot, or left or right foot on the ground or the air (e.g., volley).

At step 306, scoring prediction agent 120 may generate a second data set corresponding to player location. For example, scoring prediction agent 120 may parse through the one or more sets of event data retrieved from data store 118 to identify goalkeeper location corresponding to each shot identified therein. In some embodiments, scoring prediction agent 120 may correlate the identified goalkeeper location to a respective starting shot location.

At step 308, scoring prediction agent 120 may generate a third data set corresponding to score, time, and shot information. For example, scoring prediction agent 120 may parse through the one or more sets of event data retrieved from data store 118 to identify, for each shot, a time at which the shot was taken, a score when the shot was taken, a half wat which the shot was taken, the venue in which the shot was taken, and one or more geometric features. Such geometric features may include, but are not limited to, striker and goalkeeper angle and distance to the center of the goal and each other.

At step 310, scoring prediction agent 120 may generate a fourth data set corresponding to one or more player embeddings. For example, one or more goalkeeper embeddings may transform the learning process from learning the habits of a generic, average goalkeeper, to learning habits of each specified goalkeeper. In other words, to make the predictions more personalized, scoring prediction agent 120 may capture the identity of the goalkeeper for each shot. For each goalkeeper, scoring prediction agent 120 may be configured to generate a spatial descriptor of the goalkeeper, thus capturing the influence of the goalkeeper on the shot outcome. Such spatial descriptor may contain a large amount of information about a goalkeeper's strength and weaknesses. For example, one or more spatial descriptors may include, but are not limited to: clean sheet percentage, win percentage, save percentage for shots ending in the middle, left, and right thirds of the goal, save percentage of shots that are struck directly at them, to the right, or to the left of the goalkeeper, and the like. These spatial descriptors may be dynamic in nature. As such, the spatial descriptors may be generated on a season-level and an x-game rolling window average (e.g., 10-game) to capture hot and cold streaks of keepers.

In some embodiments, method 300 may further include step 312. At step 312, scoring prediction agent 120 may generate a fifth data set corresponding to player body pose information. For example, body pose agent 128 may be configured to generate body pose information for each striker and goalkeeper pair in the event data.

Generally, a penalty kick may be considered the most controlled scoring situation in European football. Penalty kicks typically favor the striker, with only 30% of penalty kicks being saved by the goalkeeper. To be able to determine what differentiates goalkeepers from each other, in some embodiments, scoring prediction agent 120 may go beyond event data to use more fine-grain body pose data. Such body pose data may include, but is not limited to, shooter start position and angle, run type (e.g., stutter and speed), shot initiation (e.g., body lean angle, upper body angle, hip orientation, kicking arm position, shoulder alignment, etc.), and the like.

At step 314, scoring prediction agent 120 may be configured to learn, based on the data sets, whether each scoring attempt was successful. For example, scoring prediction agent 120 may be configured to train artificial neural network 126, using the first through fifth data sets, to predict whether a goalkeeper will block or allow a shot. Because scoring prediction agent 120 takes into consideration the one or more goalkeeper embeddings, scoring prediction agent 120 may be configured to train artificial neural network 126 on a more granular basis. For example, rather than providing a determination based on that of an average goalkeeper, artificial neural network 126 may be trained to output a different prediction based on one or more spatial descriptors of the given goalkeeper.

At step 316, scoring prediction agent 120 may output a fully trained model. For example, scoring prediction agent 120 may output a fully trained model that is configured to receive shot attempt information and determine whether a particular goalkeeper will concede or block the shot attempt.

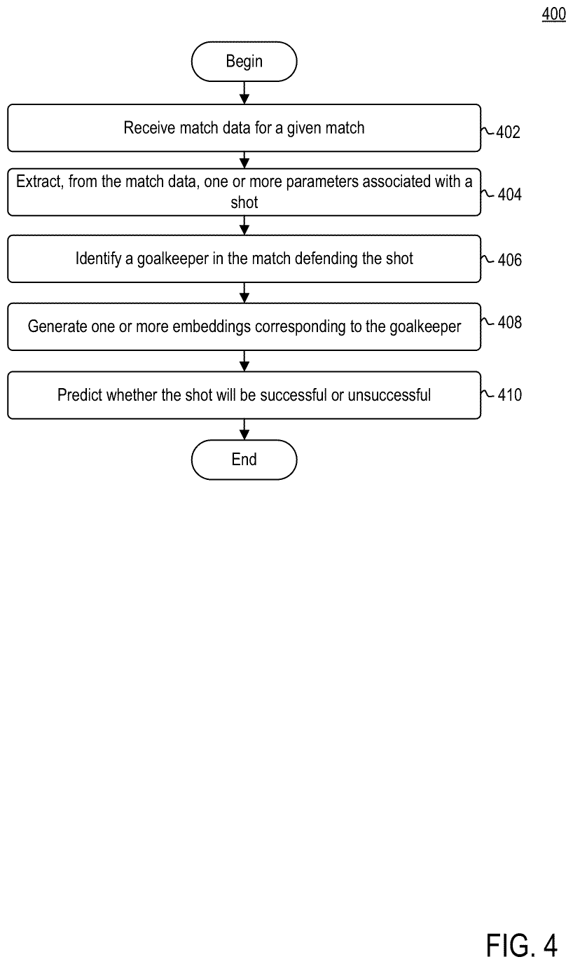

FIG. 4 is a flow diagram illustrating a method 400 of generating a shot prediction using the fully trained prediction model, according to example embodiments. Method 400 may begin at step 402.

At step 402, scoring prediction agent 120 may receive match data for a given match. For example, scoring prediction agent 120 may receive a pre-shot information for a shot attempt at a particular goalkeeper. In some embodiments, scoring prediction agent 120 may receive match data from tracking system 102. In some embodiments, scoring prediction agent 120 may receive match data from client device 108. For example, a user, via application 132, may request that a prediction be made for a given shot in a given match.

At step 404, scoring prediction agent 120 may extract, from the match data, one or more parameters associated with a shot. For example, scoring prediction agent 120 may be configured to generate one or more input values for artificial neural network 126 by selectively extracting one or more parameters associated with the shot. In some embodiments, the one or more parameters may include, but are not limited to, one or more of: shot location (x, y) coordinates, goalkeeper location (x, y, z) coordinates, current time of the game, current score of the game, venue, one or more handcrafted geometric features, shooter start position and angle run type (e.g., stutter and speed), and the like.

At step 406, scoring prediction agent 120 may identify a goalkeeper that is defending the shot. For example, scoring prediction agent 120 may parse the match data for the given match and identify the particular goalkeeper defending the shot received from the striker.

At step 408, scoring prediction agent 120 may generate identity value for the goalkeeper. In some embodiments, scoring prediction agent 120 may generate the identity value for the goalkeeper based on one or more embeddings generated during the training/testing phase of artificial neural network 126. For example, scoring prediction agent 120 may utilize the same or similar spatial descriptor of the goalkeeper that was used during the training/testing phase. This may allow artificial neural network to identify the particular goalkeeper.

At step 410, scoring prediction agent 120 may predict whether the shot attempt will be successful or unsuccessful. In other words, scoring prediction agent 120 may predict whether the goalkeeper will concede a goal or block the shot attempt. Scoring prediction agent 120 may predict the result of the shot attempt using artificial neural network 126. For example, scoring prediction agent 120 may provide, as input, to artificial neural network 126 the extracted one or more parameters associated with the shot attempt and identity information of the goal keeper. Scoring prediction agent 120 may generate, as output, a predicted outcome of the shot attempt (i.e., goal or no goal).

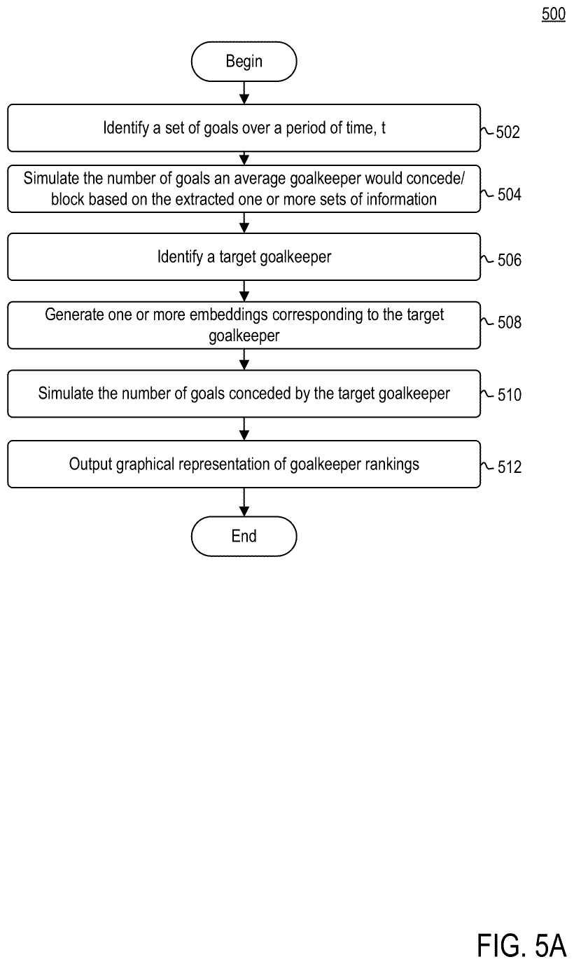

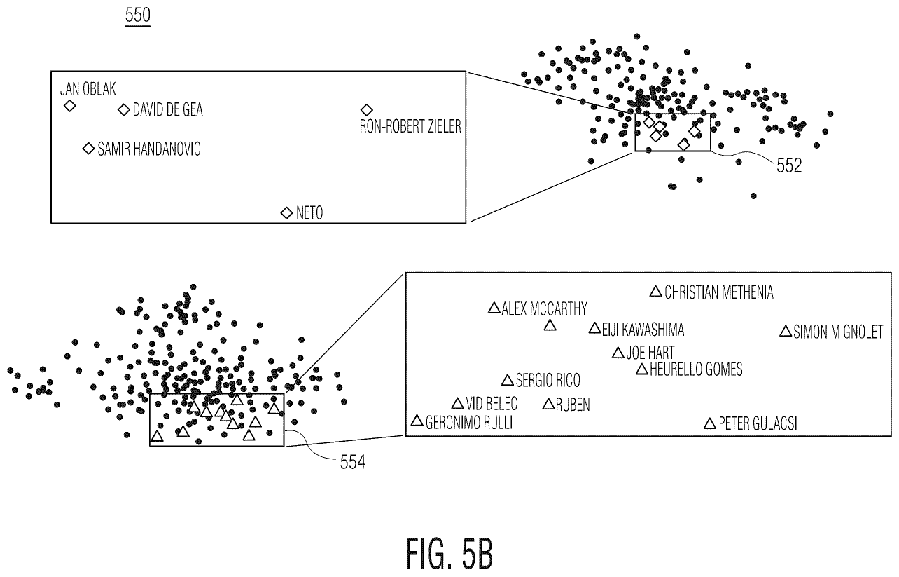

FIG. 5A is a flow diagram illustrating a method 500 of generating goalkeeper rankings based on a number of simulated goals conceded, according to example embodiments. Method 500 may begin at step 502.

At step 502, scoring prediction agent 120 may identify a set of goals over some time, t. For example, scoring prediction agent 120 may receive, from client device 108 via application 132, a request to generate a ranking of goal keeps across some period, t. In some embodiments, t may be representative of several matches, a full season, multiple seasons, and the like. In some embodiments, a user may constrain the request to a specific league (e.g., English Premier League, MLS, Bundesliga, etc.).

At step 504, scoring prediction agent 120 may simulate a number of goals an average goalkeeper would concede/block based on the identified set of goals, during the time t. For example, scoring prediction agent 120 may identify one or more parameters associated with each shot. Such parameters may include, but are not limited to, shot start location information (e.g., x, y data coordinates), goalkeeper location (e.g., x, y, z data coordinates), a time at which the shot was taken, a score when the shot was taken, a half at which the shot was taken, the venue in which the shot was taken, striker and goalkeeper angle, distance to the center of the goal and each other, and body pose data may include, but is not limited to, shooter start position and angle, run type (e.g., stutter and speed), shot initiation (e.g., body lean angle, upper body angle, hip orientation, kicking arm position, shoulder alignment, etc.), and the like.

At step 506, scoring prediction agent 120 may identify a target goalkeeper. In some embodiments, scoring prediction agent 120 may iterate through all available goalkeepers across all leagues. In some embodiments, scoring prediction agent 120 may iterate through all available goalkeepers that defended a threshold number of goals defended (e.g., at least 60). In some embodiments, a user may specify, via application 132, a set of goalkeepers to rank.

At step 508, scoring prediction agent 120 may generate one or more embeddings of the target goalkeeper. For example, scoring prediction agent 120 may inject personalized descriptor of the goalkeeper into the extracted parameters. In some embodiments, scoring prediction agent 120 may iteratively inject one or more embeddings of each goalkeeper for the analysis into the extracted parameters. By injecting the one or more personalized embeddings into the data set used to simulate the number of goals for an average keeper, scoring prediction agent 120 may generate a data set that may be used to analyze each goalkeeper's performance in relation to the average goalkeeper.

At step 510, scoring prediction agent 120 may simulate a number of goals a target goalkeeper would concede/block based on the identified set of goals during the time, t, and the one or more embeddings of the target goal keeper. For example, scoring prediction agent 120 may simulate the number of goals based on the personalized descriptor of the goalkeeper, shot start location information (e.g., x, y data coordinates), goalkeeper location (e.g., x, y, z data coordinates), a time at which the shot was taken, a score when the shot was taken, a half at which the shot was taken, the venue in which the shot was taken, striker and goalkeeper angle, distance to the center of the goal and each other, and body pose data may include, but is not limited to, shooter start position and angle, run type (e.g., stutter and speed), shot initiation (e.g., body lean angle, upper body angle, hip orientation, kicking arm position, shoulder alignment, etc.), and the like. In other words, scoring prediction agent 120 may utilize the same parameters used in step 506 above, as well as the one or more embeddings.

At step 512, scoring prediction agent 120 may output a graphical representation of goalkeeper rankings. The one or more goalkeepers may be ranked based on the number of goals blocked/conceded in relation to the average goalkeeper. In some embodiments, this may be determined by subtracting the output generated in step 508 from the output generated in step 504. For example, for each goalkeeper scoring prediction agent 120 may subject the output generated in step 512 (i.e., the goalkeeper specific output) from the output generated in step 506 (i.e., the average goal keeper output) to generate a goal+/−value. In some embodiments, the graphical representation may be a list, ranking each goalkeeper. In some embodiments, the graphical representation may be a chart ranking each goal keeper. An exemplary graphical representation is discussed below in conjunction with FIG. 5B.

FIG. 5B is a block diagram illustrating an exemplary graphical user interface 550, according to example embodiments. GUI 550 may include a graphical representation of goalkeeper dynamic embedding clusters. For example, as previously stated, because the dynamic embedding features capture differences between goalkeepers, one should be able to see significant separation in the data set, and more specifically, should see elite shot stoppers in one cluster 552 and poor shot stoppers in another cluster 554. Due to the high dimensionality of the embeddings, in some embodiments, scoring prediction agent 120 may apply a t-distributed stochastic neighbor embedding (t-SNE) multi-dimensional reduction technique to identify one or more clusters (e.g., cluster 552 and cluster 554). As illustrated, the top rated goalkeepers are included in the top cluster (i.e., cluster 552) and the bottom rated goalkeepers are included in the bottom cluster (i.e., cluster 554).

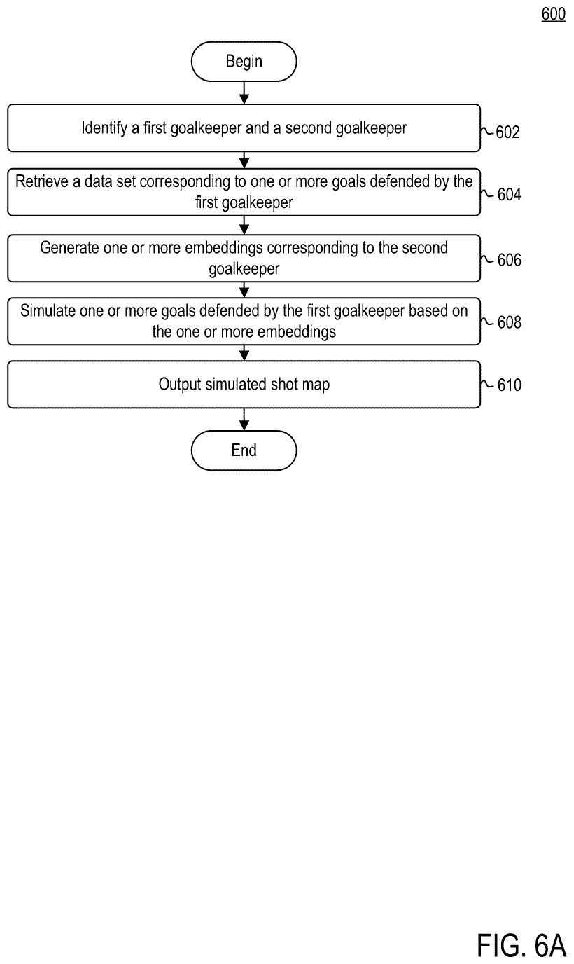

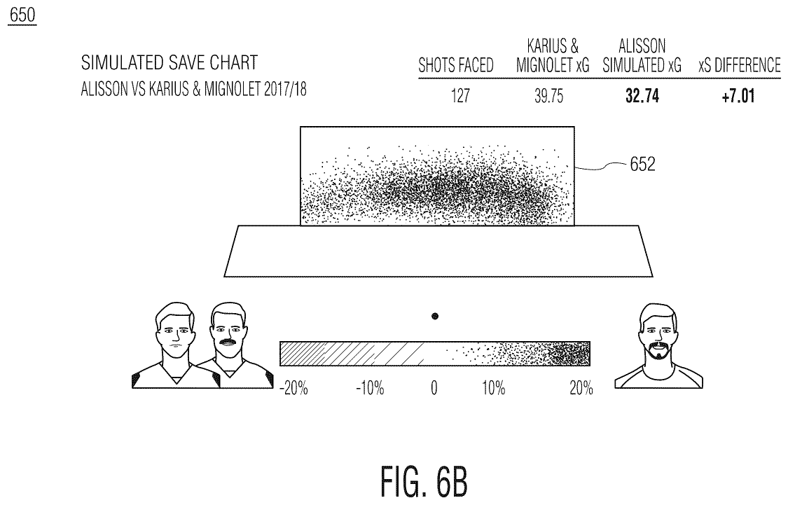

FIG. 6A is a flow diagram is a flow diagram illustrating a method 600 of comparing goalkeepers using a simulation process, according to example embodiments. Method 600 may begin at step 602.

At step 602, scoring prediction agent 120 may identify a first goalkeeper and a second goalkeeper. In some embodiments, scoring prediction agent 120 may receive a request from client device 108, via application 132, to compare the second goalkeeper to the first goal keeper. For example, scoring prediction agent 120 may receive a request to generate a more personalized goals allowed prediction by seeing how the second goalkeeper would do in place of the first goalkeeper.

At step 604, scoring prediction agent 120 may retrieve data corresponding to one or more goals defended by the first goalkeeper. For example, scoring prediction agent 120 may retrieve one or more parameters associated with one or more goals defended by the first goalkeeper over a selected period, t, where t may represent a single shot attempt, a single game, a set of games, a single season, multiple seasons, a career, etc. Such parameters may include, but are not limited to, shot start location information (e.g., x, y data coordinates), goalkeeper location (e.g., x, y, z data coordinates), a time at which the shot was taken, a score when the shot was taken, a half at which the shot was taken, the venue in which the shot was taken, striker and goalkeeper angle, distance to the center of the goal and each other, and body pose data may include, but is not limited to, shooter start position and angle, run type (e.g., stutter and speed), shot initiation (e.g., body lean angle, upper body angle, hip orientation, kicking arm position, shoulder alignment, etc.), and the like.

At step 606, scoring prediction agent 120 may generate one or more embeddings of the second goalkeeper. For example, scoring prediction agent 120 may inject personalized descriptor of the second goalkeeper into the extracted parameters. By injecting the one or more personalized embeddings into the data set corresponding to the one or more goals defended by the first goalkeeper, scoring prediction agent 120 effectively swaps goalkeeper identities to simulate how the second goalkeeper would have done against the one or more goals the first goalkeeper faced.

At step 608, scoring prediction agent 120 may simulate a number of goals the second goalkeeper would concede/block based on the identified set of goals during the time, t, and the one or more embeddings of the second goalkeeper. For example, scoring prediction agent 120 may simulate the number of goals based on the personalized descriptor of the second goalkeeper, shot start location information (e.g., x, y data coordinates), goalkeeper location (e.g., x, y, z data coordinates), a time at which the shot was taken, a score when the shot was taken, a half at which the shot was taken, the venue in which the shot was taken, striker and goalkeeper angle, distance to the center of the goal and each other, and body pose data may include, but is not limited to, shooter start position and angle, run type (e.g., stutter and speed), shot initiation (e.g., body lean angle, upper body angle, hip orientation, kicking arm position, shoulder alignment, etc.), and the like.

At step 610, scoring prediction agent 120 may output a graphical representation comparing the second goalkeeper to the first goalkeeper. In some embodiments, scoring prediction agent 120 may output a graphical representation on a shot-by-shot basis. For example, scoring prediction agent 120 may generate a shot simulation chart illustrating the number of goals conceded by the second goalkeeper in relation to the first goalkeeper. An exemplary graphical representation is discussed below in conjunction with FIG. 6B.

### Example

To demonstrate the ability of scoring prediction agent 120 in simulating goalkeeper skill, every goalkeeper who faced greater than sixty goals from the “Big Five Leagues” in Europe for the 2017/2018 seasons were simulated by swapping in their dynamic embeddings. The following are the results.

TABLE 1
Top 10 Goalkeepers

| Goalkeeper | Team | Goals+/− |
|---|---|---|
| Jan Oblak | Atletico Madrid | 0.98 |
| David De Gea | Manchester United | 0.74 |
| Samir Handanovic | Inter Milan | 0.72 |
| Pau Lopez | Real Betis | 0.68 |
| Rob-Robert Zieler | VFB Stuttgart | 0.60 |
| Marc-Andre Ter Stegen | Barcelona | 0.59 |
| Neto | Valenica | 0.59 |
| Jiri Pavlenka | Werber Bremen | 0.59 |
| Nick Pope | Burnley | 0.43 |
| Regis Gurtner | SC Amiens | 0.41 |

TABLE 2
Bottom 10 Goalkeepers

| Goalkeeper | Team | Goals+/− |
|---|---|---|
| Raul Lizoain | Las Palmas | −0.49 |
| Bingourou Kamara | RC Strasbourg | −0.52 |
| Eiji Kawashima | RC Strasbourg | −0.54 |
| Vid Belec | Benevento | −0.56 |
| Simon Mignolet | Liverpool | −0.60 |
| Alex McCarthy | Southampton | −0.60 |
| Geronimo Rulli | Real Sociedad | −0.63 |
| Heurelho Gomes | Watform | −0.79 |
| Sergio Rico | Sevilla FC | −0.88 |
| Joe Hart | West Ham United | −1.19 |

FIG. 6B is a block diagram of a graphical user interface 650 illustrating a simulated shot map 652, according to example embodiments. As illustrated, simulated shot map 652 may illustrate the analysis of goals defended by Liverpool goalkeepers, Loris Karius and Simon Mignolet, and how Alisson would have performed against the same shots. Such analysis may be performed using one or more operations discussed above in conjunction with FIG. 6A by, for example, swapping identities (i.e., spatial descriptors). In some embodiments, simulated shot map 652 may be a weighted two-dimensional Gaussian distribution of whether Liverpool conceded shots for the 2017/2018 season. Each shot may be weighted by the differences in the expected saves between the goalkeepers. First color shows where Alisson increased the chance of saving a shot and shows where Karius/Mignolet increases the chance. As illustrated, no part of simulated shot map 652 is second color. As such, taking every shot into account, had Alisson played for Liverpool in the 2017/2018 season, they could have expected to concede seven fewer goals.

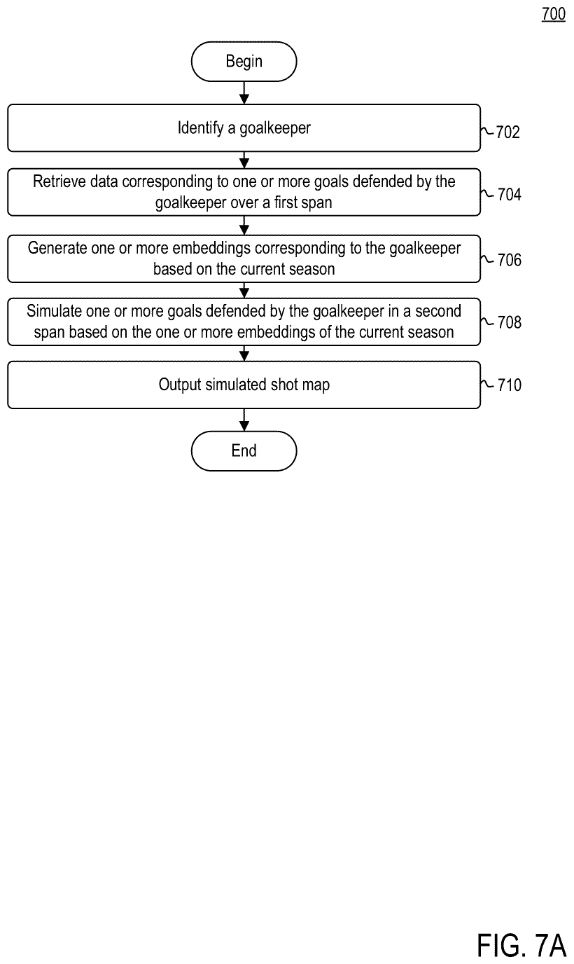

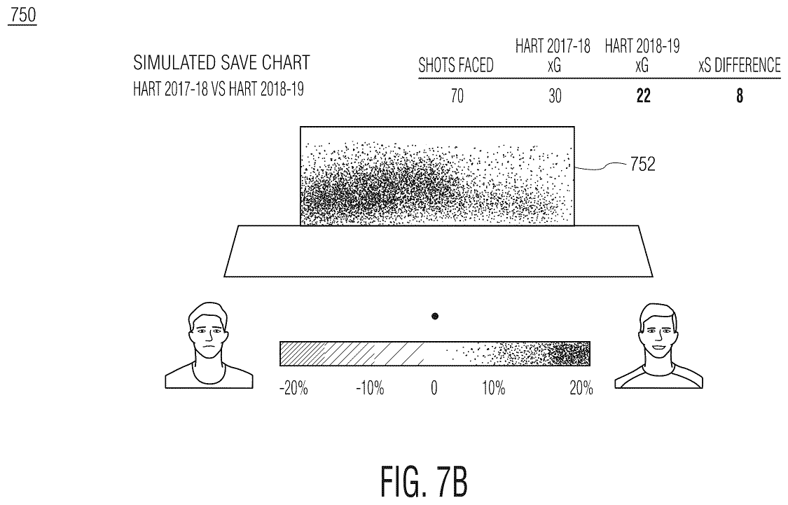

FIG. 7A is a flow diagram illustrating a method 700 of comparing goalkeeper seasons using a simulation process, according to example embodiments. Method 700 may begin at step 702.

At step 702, scoring prediction agent 120 may identify a target goalkeeper. In some embodiments, scoring prediction agent 120 may receive a request from client device 108, via application 132, to compare a target goalkeeper in his or her current form to a previous form of the goalkeeper. In other words, scoring prediction agent 120 may receive a request to analyze goalkeeper behavior to determine if a goalkeeper has improved over the course of a career, season, span of games, and the like.

At step 704, scoring prediction agent 120 retrieve data corresponding to one or more goals defended by the goalkeeper over a first span. For example, scoring prediction agent 120 may retrieve one or more parameters associated with one or more goals defended by the target goalkeeper over a first time span, t, where t may represent a single shot attempt, a single game, a set of games, a single season, multiple seasons, etc. Such parameters may include, but are not limited to, shot start location information (e.g., x, y data coordinates), goalkeeper location (e.g., x, y, z data coordinates), a time at which the shot was taken, a score when the shot was taken, a half at which the shot was taken, the venue in which the shot was taken, striker and goalkeeper angle, distance to the center of the goal and each other, and body pose data may include, but is not limited to, shooter start position and angle, run type (e.g., stutter and speed), shot initiation (e.g., body lean angle, upper body angle, hip orientation, kicking arm position, shoulder alignment, etc.), and the like.

At step 706, scoring prediction agent 120 may generate one or more embeddings corresponding to the target goalkeeper based on a second time span, wherein the second time span is different from the first time span. For example, scoring prediction agent 120 may inject personalized descriptor of the second goalkeeper based on the second time space into the extracted parameters. By injecting the one or more personalized embeddings into the data set corresponding to the one or more goals defended by the first goalkeeper, scoring prediction agent 120 effectively swaps goalkeeper identities to simulate how the target goalkeeper, in the form represented during the second time span, would have done against the one or more goals the target goalkeeper faced in the form represented during the first time frame. Such operations are possible due to the dynamic nature of goalkeeper embeddings that may change season-to-season, game-to-game, and the like.

At step 708, scoring prediction agent 120 may simulate a number of goals the target goalkeeper would concede/block, in the form represented in the second time span, based on the identified set of goals during the first time span and the one or more embeddings of the target goalkeeper generated using goalkeeper data in the second time span. For example, scoring prediction agent 120 may simulate the number of goals based on the personalized descriptor of the second goalkeeper in the second time span, shot start location information (e.g., x, y data coordinates), goalkeeper location (e.g., x, y, z data coordinates), a time at which the shot was taken, a score when the shot was taken, a half at which the shot was taken, the venue in which the shot was taken, striker and goalkeeper angle, distance to the center of the goal and each other, and body pose data may include, but is not limited to, shooter start position and angle, run type (e.g., stutter and speed), shot initiation (e.g., body lean angle, upper body angle, hip orientation, kicking arm position, shoulder alignment, etc.), and the like.

At step 710, scoring prediction agent 120 may output a graphical representation comparing the performances of the target goalkeeper. In some embodiments, scoring prediction agent 120 may output a graphical representation on a shot-by-shot basis. For example, scoring prediction agent 120 may generate a shot simulation chart illustrating the number of goals conceded by the target second goalkeeper had the goalkeeper been in the form represented in the second time span. An exemplary graphical representation is discussed below in conjunction with FIG. 7B.

FIG. 7B is a block diagram of a graphical user interface 750 illustrating a simulated shot map 752, according to example embodiments. As discussed above in Table 2, Joe Hart was one of the lowest performing goalkeepers in the big 5 leagues for the 2017-18 season. Using the one or more operations discussed above in conjunction with FIG. 7A, scoring prediction agent 120 may determine whether this ranking is permanent or if it evolved over time. As previously stated, because an embedding may be dynamic in nature, scoring prediction agent 120 may be able to measure how a goalkeeper changes from, for example, season to season. Simulated shot map 150 illustrates how Joe Hart in 2018-19 form would have fared against the shot attempts that Joe Hart in 2017-18 defended. In some embodiments, simulated shot map 752 may be a weighted two-dimensional Gaussian distribution. Each shot may be weighted by the differences in the expected saves between 2018-19 Joe Hart and 2017-18 Joe hart. First color (e.g., Grey) shows where 2018-19 Joe Hart increased the chance of saving a shot and second color (e.g., shows where 2017-2018 Joe Hart increases the chance. As illustrated, no part of simulated shot map 652 is second color. As such, taking every shot into account, had 2018-19 Joe Hart played for West Ham in the 2017/2018 season instead of 2017-18 Joe Hart, they could have expected to concede eight fewer goals.

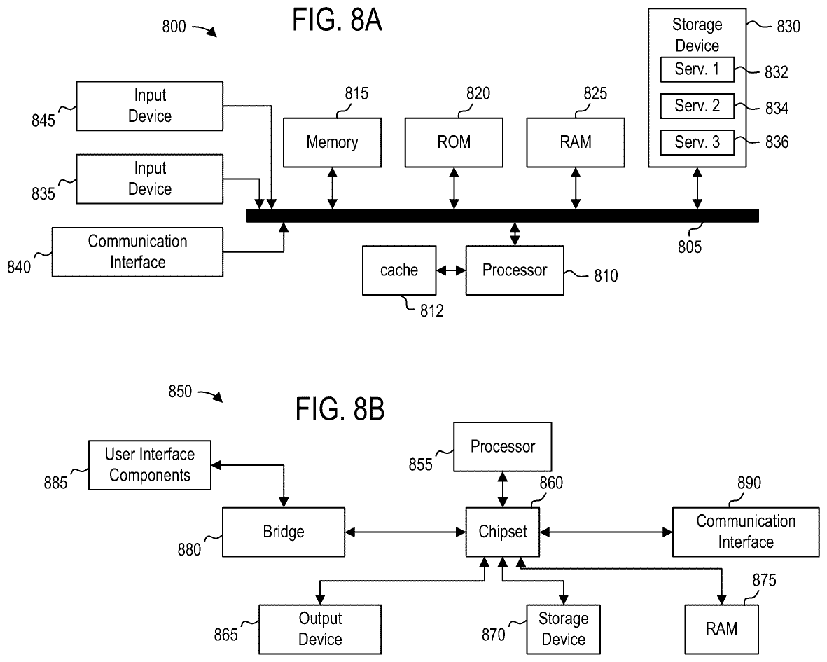

FIG. 8A illustrates a system bus computing system architecture 800, according to example embodiments. System 800 may be representative of at least a portion of organization computing system 104. One or more components of system 800 may be in electrical communication with each other using a bus 805. System 800 may include a processing unit (CPU or processor) 810 and a system bus 805 that couples various system components including the system memory 815, such as read only memory (ROM) 820 and random access memory (RAM) 825, to processor 810. System 800 may include a cache of high-speed memory connected directly with, in close proximity to, or integrated as part of processor 810. System 800 may copy data from memory 815 and/or storage device 830 to cache 812 for quick access by processor 810. In this way, cache 812 may provide a performance boost that avoids processor 810 delays while waiting for data. These and other modules may control or be configured to control processor 810 to perform various actions. Other system memory 815 may be available for use as well. Memory 815 may include multiple different types of memory with different performance characteristics. Processor 810 may include any general purpose processor and a hardware module or software module, such as service 1 832, service 2 834, and service 3 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction with the computing device 800, an input device 845 may represent any number of input mechanisms, such as a microphone for speech, a touch-sensitive screen for gesture or graphical input, keyboard, mouse, motion input, speech and so forth. An output device 835 may also be one or more of a number of output mechanisms known to those of skill in the art. In some instances, multimodal systems may enable a user to provide multiple types of input to communicate with computing device 800. Communications interface 840 may generally govern and manage the user input and system output. There is no restriction on operating on any particular hardware arrangement and therefore the basic features here may easily be substituted for improved hardware or firmware arrangements as they are developed.

Storage device 830 may be a non-volatile memory and may be a hard disk or other types of computer readable media which may store data that are accessible by a computer, such as magnetic cassettes, flash memory cards, solid state memory devices, digital versatile disks, cartridges, random access memories (RAMs) 825, read only memory (ROM) 820, and hybrids thereof.

Storage device 830 may include services 832, 834, and 836 for controlling the processor 810. Other hardware or software modules are contemplated. Storage device 830 may be connected to system bus 805. In one aspect, a hardware module that performs a particular function may include the software component stored in a computer-readable medium in connection with the necessary hardware components, such as processor 810, bus 805, display 835, and so forth, to carry out the function.

FIG. 8B illustrates a computer system 850 having a chipset architecture that may represent at least a portion of organization computing system 104. Computer system 850 may be an example of computer hardware, software, and firmware that may be used to implement the disclosed technology. System 850 may include a processor 855, representative of any number of physically and/or logically distinct resources capable of executing software, firmware, and hardware configured to perform identified computations. Processor 855 may communicate with a chipset 860 that may control input to and output from processor 855. In this example, chipset 860 outputs information to output 865, such as a display, and may read and write information to storage device 870, which may include magnetic media, and solid state media, for example. Chipset 860 may also read data from and write data to RAM 875. A bridge 880 for interfacing with a variety of user interface components 885 may be provided for interfacing with chipset 860. Such user interface components 885 may include a keyboard, a microphone, touch detection and processing circuitry, a pointing device, such as a mouse, and so on. In general, inputs to system 850 may come from any of a variety of sources, machine generated and/or human generated.

Chipset 860 may also interface with one or more communication interfaces 890 that may have different physical interfaces. Such communication interfaces may include interfaces for wired and wireless local area networks, for broadband wireless networks, as well as personal area networks. Some applications of the methods for generating, displaying, and using the GUI disclosed herein may include receiving ordered datasets over the physical interface or be generated by the machine itself by processor 855 analyzing data stored in storage 870 or 875. Further, the machine may receive inputs from a user through user interface components 885 and execute appropriate functions, such as browsing functions by interpreting these inputs using processor 855.

It may be appreciated that example systems 800 and 850 may have more than one processor 810 or be part of a group or cluster of computing devices networked together to provide greater processing capability.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed:

1. A method comprising:
receiving, by a processor of a computing system, real-time tracking data from a tracking system for a sporting event between a first team and a second team,
wherein the tracking system comprises an optically-based system using one or more cameras, and wherein the tracking system records motion of one or more players or one or more objects associated with the sporting event;
identifying, by the processor of the computing system, a scoring attempt event in the real-time tracking data for the sporting event;
determining, by the computing system, a set of players involved in the scoring attempt event, the set of players comprising a defensive player defending the scoring attempt event and an offensive player initiating the scoring attempt event;
extracting, by the processor of the computing system, one or more features related to the scoring attempt event, the one or more features comprising body pose information of the offensive player;
predicting, by the processor of the computing system, a likely outcome of the scoring attempt event based on the one or more features related to the scoring attempt event; and
outputting, by the processor of the computing system, a graphical representation of the likely outcome of the scoring attempt for visual depiction via a display.

2. The method of claim 1, wherein extracting, by the computing system, the one or more features related to the scoring attempt event comprises:
identifying one or more geometric features corresponding to the scoring attempt event based on the one or more features, the one or more geometric features comprising one or more of an angle between the offensive player and the defensive player, a first distance from the offensive player to a center of a goal, or a second distance from the defensive player to the center of the goal.

3. The method of claim 1, wherein extracting, by the computing system, the one or more features related to the scoring attempt event comprises:
identifying the body pose information of the offensive player initiating the scoring attempt event based on the one or more features, wherein the body pose information includes offensive player start position, angle, run type, or shot initiation.

4. The method of claim 1, further comprising:
identifying, by the computing system, a second defensive player; and
predicting, by the computing system, a second likely outcome of the scoring attempt event by replacing the defensive player with the second defensive player.

5. The method of claim 4, further comprising:
generating, by the computing system, a graphical representation comparing the likely outcome of the scoring attempt event with the defensive player to the second likely outcome of the scoring attempt event with the second defensive player.

6. The method of claim 1, further comprising:
identifying, by the computing system, a second offensive player; and
predicting, by the computing system, a second likely outcome of the scoring attempt event by replacing the offensive player with the second offensive player.

7. The method of claim 6, further comprising:
generating, by the computing system, a graphical representation comparing the likely outcome of the scoring attempt event with the offensive player to the second likely outcome of the scoring attempt event with the second offensive player.

8. A non-transitory computer readable medium comprising one or more sequences of instructions, which, when executed by a processor, causes a computing system to perform operations comprising:
receiving, by the processor of the computing system, real-time tracking data from_a tracking system for a sporting event between a first team and a second team;
identifying, by the computing system, a scoring attempt event in the tracking data for the sporting event, wherein the tracking system comprises an optically-based system using one or more cameras, and wherein the tracking system records motion of one or more players or one or more objects associated with the sporting event;
determining, by the processor of the computing system, a set of players involved in the scoring attempt event, the set of players comprising a defensive player defending the scoring attempt event and an offensive player initiating the scoring attempt event;
extracting, by the processor of the computing system, one or more features related to the scoring attempt event, the one or more features comprising body pose information of the offensive player;
predicting, by the processor of the computing system, a likely outcome of the scoring attempt event based the one or more features related to the scoring attempt event; and
outputting, by the processor of the computing system, a graphical representation of the likely outcome of the scoring attempt for visual depiction via a display.

9. The non-transitory computer readable medium of claim 8, wherein extracting, by the computing system, the one or more features related to the scoring attempt event comprises:
identifying one or more geometric features corresponding to the scoring attempt event based on the one or more features, the one or more geometric features comprising one or more of an angle between the offensive player and the defensive player, a first distance from the offensive player to a center of a goal, or a second distance from the defensive player to the center of the goal.

10. The non-transitory computer readable medium of claim 8, wherein extracting, by the computing system, the one or more features related to the scoring attempt event comprises:
identifying the body pose information of the offensive player initiating the scoring attempt event based on the one or more features, wherein the body pose information includes offensive player start position, angle, run type, or shot initiation.

11. The non-transitory computer readable medium of claim 8, further comprising:
identifying, by the computing system, a second defensive player; and
predicting, by the computing system, a second likely outcome of the scoring attempt event by replacing the defensive player with the second defensive player.

12. The non-transitory computer readable medium of claim 11, further comprising:
generating, by the computing system, a graphical representation comparing the likely outcome of the scoring attempt event with the defensive player to the second likely outcome of the scoring attempt event with the second defensive player.

13. The non-transitory computer readable medium of claim 8, further comprising:
identifying, by the computing system, a second offensive player; and
predicting, by the computing system, a second likely outcome of the scoring attempt event by replacing the offensive player with the second offensive player.

14. The non-transitory computer readable medium of claim 13, further comprising:
generating, by the computing system, a graphical representation comparing the likely outcome of the scoring attempt event with the offensive player to the second likely outcome of the scoring attempt event with the second offensive player.

15. A system comprising:
a processor; and
a memory having programming instructions stored thereon, which, when executed by the processor, causes the system to perform operations comprising:
receiving real-time tracking data from a tracking system for a sporting event between a first team and a second team,
wherein the tracking system comprises:
an optically-based system using one or more cameras, and
wherein the tracking system records motion of one or more players or one or more objects associated with the sporting event;
identifying a scoring attempt event in the real-time tracking data for the sporting event;
determining a set of players involved in the scoring attempt event, the set of players comprising a defensive player defending the scoring attempt event and an offensive player initiating the scoring attempt event;
extracting one or more features related to the scoring attempt event, the one or more features comprising body pose information of the offensive player;
predicting a likely outcome of the scoring attempt event based the scoring attempt event; and
outputting a graphical representation of the likely outcome of the scoring attempt for visual depiction via a display.

16. The system of claim 15, wherein extracting the one or more features related to the scoring attempt event comprises:
identifying one or more geometric features corresponding to the scoring attempt event based on the one or more features, the one or more geometric features comprising one or more of an angle between the offensive player and the defensive player, a first distance from the offensive player to a center of a goal, or a second distance from the defensive player to the center of the goal.

17. The system of claim 15, wherein extracting the one or more features related to the scoring attempt event comprises:
identifying the body pose information of the offensive player initiating the scoring attempt event based on the one or more features, wherein the body pose information includes offensive player start position, angle, run type, or shot initiation.

18. The system of claim 15, wherein the operations further comprise:
identifying a second defensive player; and
predicting a second likely outcome of the scoring attempt event by replacing the defensive player with the second defensive player.

19. The system of claim 18, wherein the operations further comprise:
generating a graphical representation comparing the likely outcome of the scoring attempt event with the defensive player to the second likely outcome of the scoring attempt event with the second defensive player.

20. The system of claim 15, wherein the operations further comprise:
identifying a second offensive player; and
predicting a second likely outcome of the scoring attempt event by replacing the offensive player with the second offensive player.
